(19) United States
(12) Patent Application Publication
(10) Pub. No.: US 2016/0288957 A1
(43) Pub. Date: Oct. 6, 2016

(54) SPORTS EQUIPMENT CARRYING AND STORAGE DEVICE

(71) Applicant: Timothy Jackowiak, Crystal Lake, IL (US)

(72) Inventor: Timothy Jackowiak, Crystal Lake, IL (US)

(21) Appl. No.: 15/086,915

(22) Filed: Mar. 31, 2016

Related U.S. Application Data
(60) Provisional application No. 62/142,891, filed on Apr. 3, 2015.

(51) Int. Cl. B65D 25/20; B65D 25/28; A01K 97/04

(52) U.S. Cl. CPC B65D 25/20; A01K 97/04; B65D 25/28

(57) ABSTRACT

A device or apparatus useful for simultaneously carrying and/or storing multiple pieces of sports equipment, is provided. The device enables a user to carry multiple pieces of sports equipment at one time in an organized manner. Additionally, the device and its securing elements are adjustable such that the various pieces of sports equipment can be carried in different positions or orientations, as needed. The present device is further adaptable for use with a bag, luggage, equipment bag, tackle box or other form of carryall, wherein the handle of the bag is utilized to engage and secure the device and associated equipment. Finally, the present device is also useful for storing sports equipment when not in use.

This application claims priority under 35 U.S.C. §119(e) to U.S. Application Ser. No. 62/142,891, filed on Apr. 3, 2015, which is incorporated by reference herein in its entirety.

### TECHNICAL FIELD

The present invention relates to transporting and storing of sports equipment. Specifically, the present disclosure relates to a hands-free, adjustable device for carrying and storing sports equipment, including fishing tackle. However, it should be understood that the present device may be useful for transporting and storing other forms of sports equipment, including tennis or racquetball rackets, baseball bats, lacrosse sticks, hockey sticks, etc., as well as other associated gear. Additionally, the present device is useful with bags and other carryalls ideally having handles, including equipment bags, tackle boxes, luggage, and general carryalls.

### BACKGROUND

It is, of course, generally known that recreational and professional sports require numerous pieces of equipment and gear. Various sports, including but not limited to ball sports such baseball, tennis, golf and racquetball, all require numerous items, including racquets, baseball bats, balls, clubs, etc., to be carried to and from the chosen location for play. Other forms of recreational sports, including fishing and hunting, can also require numerous items, including fishing rods, tackle boxes, guns, and even hunting blinds or stands. No matter what the sport, efficiently carrying all of the gear, especially by one person, can be burdensome and awkward.

For example, fishing is widely accepted as a recreational activity, and the burden of carrying cumbersome tackle can deny an angler of some of the enjoyment of the experience. Fishing typically requires numerous items, including several fishing rods, nets, tackle boxes and other associated gear, which needs to be transported from an initial starting point to and from the chosen fishing location. However, carrying several items, including multiple fishing rods, tackle box, nets and other associated gear can be physically challenging for the angler. The more tackle an angler chooses to employ and the more distance an angler must cover to get to the desired fishing location, the more challenging the transport of equipment can become. Many anglers carry a tackle box in addition to one or several fishing rods, nets or other associated tackle. By design, fishing rods can be awkward to carry, either vertically or horizontally.

Therefore, a need exists for a device useful for carrying multiple pieces of sports equipment. Specifically, a need exists for a device useful for conveniently and easily carrying multiple pieces of sports equipment at one time.

A need further exists for a device useful for carrying sports equipment in different convenient positions or orientations.

A need further exists for a device useful for storing sports equipment when not in use.

A need further exists for a device that is easily adjustable for carrying and storing multiple pieces of sports equipment at one time.

Additionally, a need exists for a device adaptable for use in conjunction with an existing bag or carryall to assist with the transport of one or multiple pieces of sports equipment at one time. Alternatively, the device is adapted for carrying by hand.

A need further exists for a device having adjustable securing features or elements for carrying multiple items of sports equipment of differing sizes.

Additionally, a need exists for a device having adjustable securing features or elements for carrying sports equipment in different positions oriented to the user and/or the associated bag or carryall.

A need further exists for a device useful for carrying multiple pieces of equipment useful for fishing.

Additionally, a need exists for a device adaptable for use in conjunction with an existing tackle box handle to assist with the transport of one or more fishing rods, nets or other associated tackle.

### SUMMARY

The present invention relates to a device useful for simultaneously carrying and/or storing multiple pieces of sports equipment. In particular, the present disclosure relates to a device useful for carrying and storing multiple pieces of sports equipment by a user, the device being adjustable for carrying various items of sports equipment in different positions or orientations such that carrying multiple pieces of sports equipment is more balanced for the user. The present device is further adaptable for use with a bag, equipment bag, tackle box, luggage or other form of carryall ideally having a handle for engagement with the device.

To this end, in an embodiment of the present invention, a sports equipment carrying device is disclosed. The device comprises a main body and at least one leg connected perpendicular to and extending from a side of the body, and a plurality of securement elements extending from the leg.

A sports equipment carrying and storage device is disclosed. The device comprises a body having a center opening there through, at least two legs connected perpendicular to and extending from opposing ends of the body, and a plurality of securement elements projecting outward from each leg, wherein the securement elements further comprise at least one adjustable strap having a plurality of fasteners disposed thereon for engagement with a plurality of receiving elements on each leg.

It is, therefore, an advantage and objective of the present disclosure to provide a device useful for carrying multiple pieces of sports equipment at one time.

Another advantage and objective of the present disclosure is to provide a device that is adjustable to accommodate various sizes of sports equipment.

It is a further advantage and objective of the present disclosure to provide a device that is adaptable for carrying and or storing various pieces of sports equipment in different orientations convenient to the user.

It is yet a further advantage and objective of the present disclosure to provide a device useful for carrying various items of sports equipment in an organized manner.

It is yet another advantage and objective of the present disclosure to provide a device that is adaptable for use with various bags and/or other carryalls.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a sports equipment carrying and storage device of the present disclosure in use on a tackle box;

FIG. 2 illustrates a perspective view of the sports equipment carrying and storage device of the present disclosure;

FIG. 3 illustrates another embodiment of the sports equipment carrying and storage device of the present disclosure incorporating a different securement feature;

FIG. 4 illustrates yet another embodiment of the sports equipment and storage device of the present disclosure incorporating another securement feature;

FIG. 5 illustrates another embodiment of the sports equipment and storage device of the present disclosure incorporating yet another securement feature;

FIG. 6 illustrates a perspective view of a sports equipment carrying and storage device of the present disclosure in use on a tackle box supporting multiple fishing rods in different positions;

FIG. 7 illustrates a perspective view of another embodiment of a sports equipment carrying and storage device of the present disclosure;

FIG. 8 illustrates a perspective view of a sports equipment carrying and storage device of the present disclosure supporting various different sports equipment items.

### DETAILED DESCRIPTION

The present invention relates to a device or apparatus useful for simultaneously carrying and/or storing multiple pieces of sports equipment. In particular, the present disclosure relates to a device that enables the user to carry multiple pieces of sports equipment at one time. Additionally, the device and its securing elements are adjustable such that the various pieces of sports equipment can be carried in different positions, and in different orientations to the user, as needed.

The present device is further adaptable for use with a bag, luggage, equipment bag, tackle box, tote, case, etc., or other form of carryall, wherein the handle of the bag is utilized to engage the device and associated equipment. It should be understood that the term “bag” is used as a general term for any form of carryall, and is not limiting. In this manner, the device offers essentially a hands-free option for carrying multiple items by using the device with an appropriate carryall. Finally, the present device is also useful for storing sports equipment when not in use.

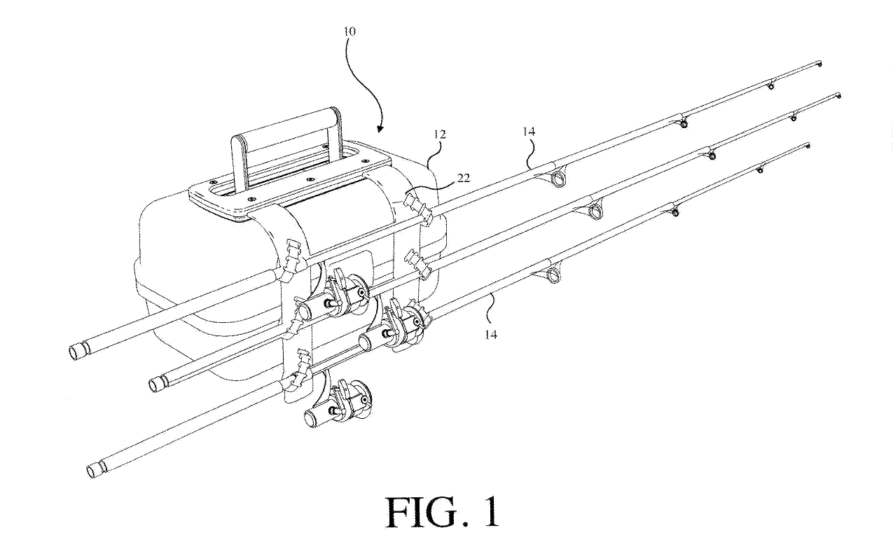

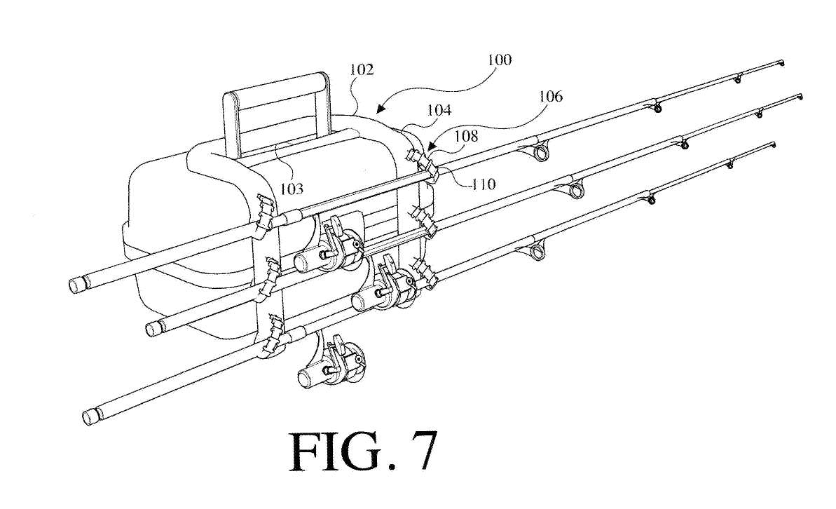

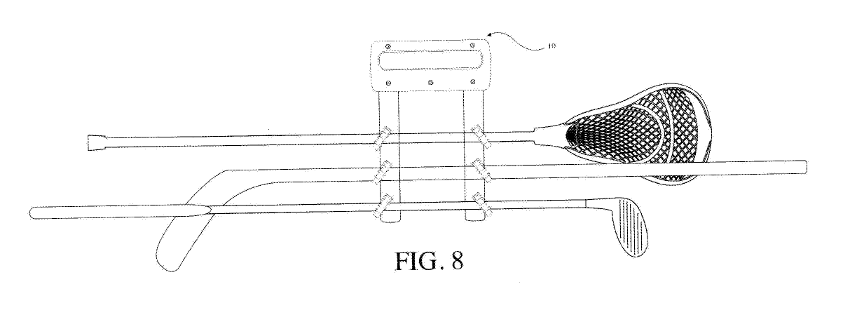

Now referring to the figures, wherein like numerals refer to like parts, FIGS. 1-6 illustrate an embodiment of the sports equipment carrying and storage device 10 of the present disclosure. FIG. 7 illustrates another embodiment of the sports equipment carrying and storage device 100 of the present disclosure. FIG. 1 illustrates one embodiment of the device 10, wherein the device is used in conjunction with a tackle box 12 for carrying multiple fishing rods 14. FIG. 8 illustrates and embodiment of the present device 10, wherein the device is useful for carrying different forms of sports equipment, such as lacrosse sticks, golf clubs and hockey sticks. It should be understood that the device 10 can be used with practically any carrying-style item having a handle that the device can fit over. Once the device 10 is fit over the handle, grasping the handle secures the device to the bag. In some instances, items with longer handles, such as luggage, will easily secure the device in place. Optionally, the device 10 can be used as a storage device, including hanging it on a wall.

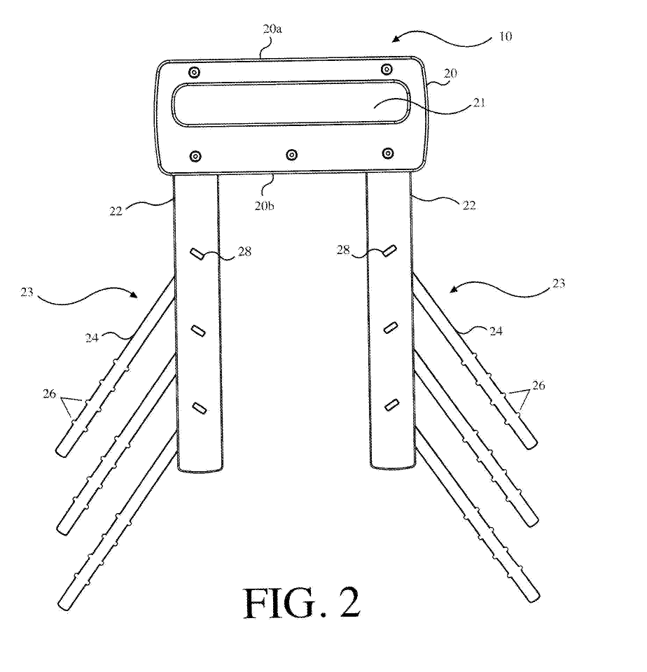

As shown in FIG. 2, the device 10 includes a main body 20 having a top side 20a and a bottom side 20b. The main body 20 can constructed from any suitable material that provides a rigid configuration, including plastics, rubber, wood, or metals. The main body 20 further includes a center opening 21, which is adapted for placing over the handle of a preferred carrying case, thereby securing the device in place. In a present embodiment, the main body 20 has a rectangular shape; however, it should be understood that the main body can have any suitable shape, including, but not limited to, circular, oval and square.

The device 10 further includes at least one leg 22 extending perpendicular from the bottom side 20b of the main body 20. The leg or legs 22 can be attached to the main body 20 either using know fasteners, such as screws, or alternatively, the legs and main body may be formed as one continuous piece (FIG. 7). As shown in the embodiment of FIG. 2, two legs 22 are attached to and extend from the opposing ends of the bottom side 20b of the main body 20 and positioned parallel to one another. In this manner, pieces of sports equipment can be positioned across the legs 22, and secured in a balanced, oriented position (FIG. 1), which facilitates carrying longer items. Alternatively, the device 10 may include any number of legs.

The legs 22 are constructed from a strong, but flexible material, such as a plastic, rubber or silicone. Flexibility of the material is preferred because it is desirable to have the legs malleable to the shape of the outer surface of the chosen carrying case, resulting in a more compact design. For example, FIG. 1 illustrates the legs 22 wrapping down the outer surface of the tackle box 12, creating a more compact design.

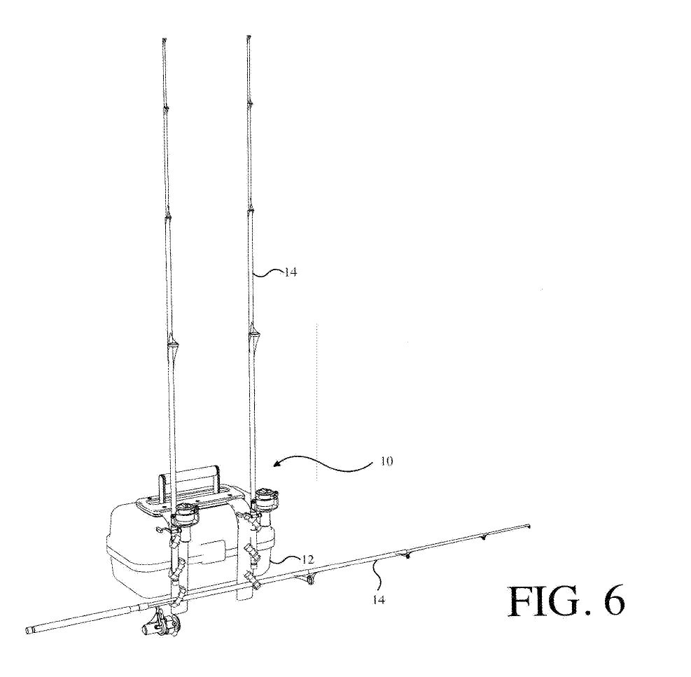

The legs 22 of the device each include at least one securement element 23 in the form of a strap 24. The straps 24 generally formed as one piece with the leg and extend outward from the side of the legs 22. As shown in FIG. 2, the straps 24 extend outward and angle downward away from a side of the leg. In particular, the straps 24 are generally angled downward at more than 90° degrees away from the side of the leg. Optionally, the straps 24 can be positioned at any suitable angle. Configured in this manner permits the strap 24 to be wrapped up and around a particular piece of sports equipment, securing it into position. In addition, the angled straps 24 permit securing items in multiple positions or orientations to the carrying case or bag. For example, the items can be secured into a horizontal position, as shown in FIG. 1, as well as in a vertical position, as shown in FIG. 6.

It should be understood that while the particular embodiment shows three securement elements 23, any number of securement elements can be positioned on the individual legs 22. Preferably, the same number of securement elements 23 are found on each leg 22, so that the items can be secured in a balanced fashion. The securement elements 23 are constructed from a strong, but flexible material, such as a rubber or silicone, because it is desirable to wrap the securement elements around the item to be secured to the carrying case or bag. For example, FIG. 1 illustrates the securement elements 23 wrapping around multiple fishing rods 14.

The straps 24 further include a plurality of fasteners running along a length of the strap. FIGS. 2 through 4 illustrate the straps 24 each having a different type of fastener. For example, FIG. 2 illustrates an embodiment wherein the fastener is a protrusion 26. Multiple protrusions 26 are positioned along a length of the straps 24. Like the straps 24, the protrusions 26 are constructed from a similar flexible material. When in use, the flexible strap or straps 24 are wrapped around the item of sports equipment. The strap 24 is fed through a corresponding receiver or opening 28 in the respective leg 22, wherein the protrusion 26 is fed through the opening. The circumference of the protrusion 26 is slightly larger than the receiving opening 28, such that the protrusion secures the strap in position after being fed through the opening. The plurality of protrusions 26 along the length of the strap 24 permits the strap to be adjustable for receiving any item of sports equipment having a variable circumference or size. Feeding the straps 24 and protrusions 26 through the openings 28 on the legs 22 also keeps the ends of the strap against the carrying bag, and out of the way of the equipment and user.

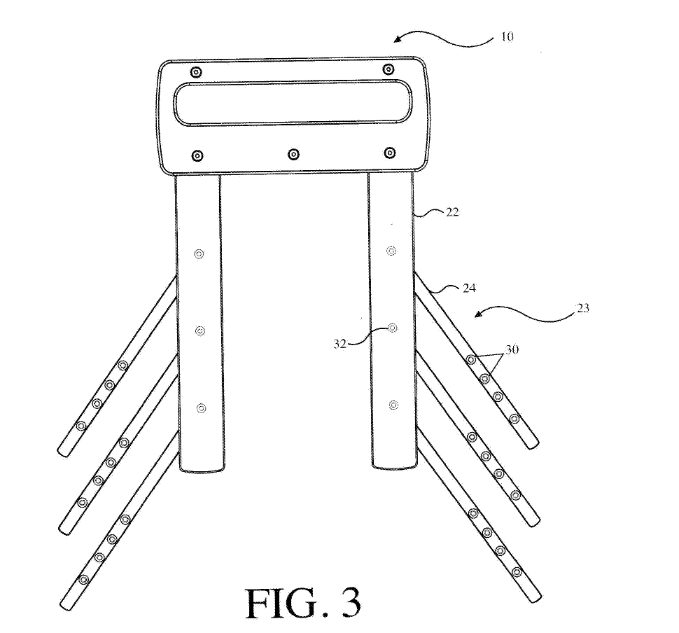

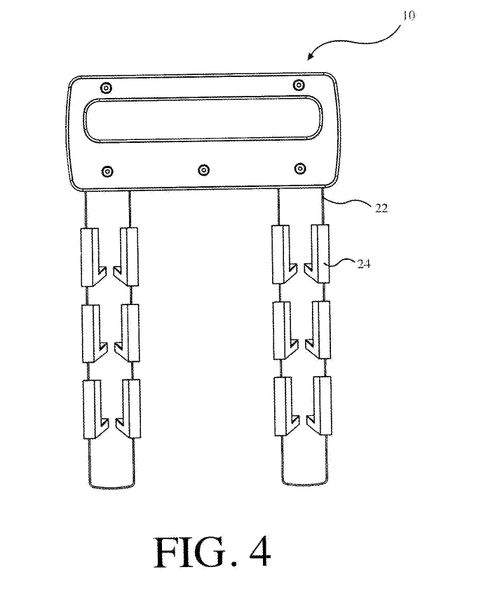

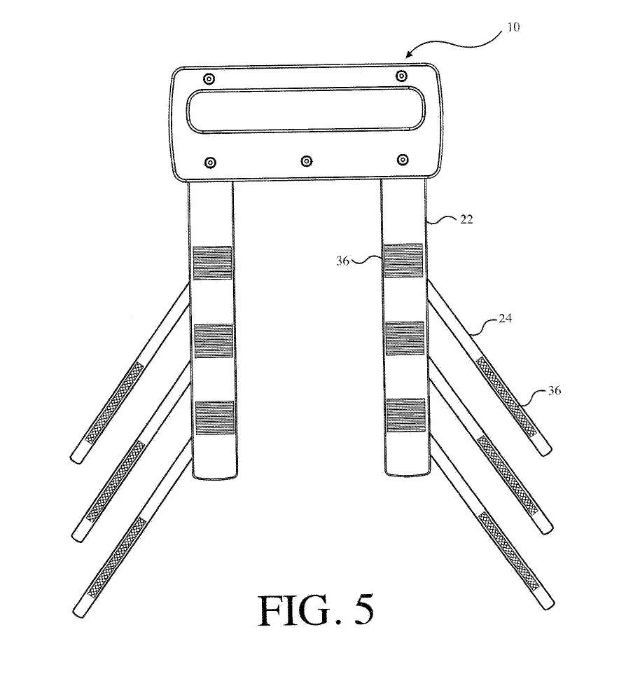

It should be recognized that a variety of fasteners may be useful with the present device 10. FIGS. 3-5 illustrate alternative embodiments of fasteners that may be useful in the present device 10. FIG. 3 illustrates snaps 30 on the straps 24, which can be secured to corresponding receivers 32 on the legs 22. As with the protrusions 26 mentioned above, any number of snaps 30 can be positioned along the strap, allowing the strap to accommodate sports equipment of varying sizes. FIG. 4 illustrates hooks 34 as a possible fastener, where the item is placed across the hooks. The hooks 34 may be constructed from a flexible material, that can slight expand to accommodate an item, but have the ability to contract back into place to secure the item. FIG. 5 illustrates using hook and loop fasteners 36 on the straps 24 and the respective legs 22. It should be understood that multiple forms of fasteners may be useful with the present device 10. Preferred fasteners permit adjustability for receiving and securing sports equipment of varying sizes, as well as those that provide the option of holding the sports equipment in different positions. FIG. 6 provides one illustration of securing and carrying sports equipment—fishing rods in this instance—in different positions or orientations to the carrying case 12.

FIG. 7 illustrates yet another embodiment of the present device 100. This particular embodiment is constructed having a unitary main body 102, preferably constructed from a flexible rubber or silicone, for example, through injection-molding. As with the previous embodiments, the unitary main body 102 of the present device 100 includes with a center opening 103 for receiving a handle from a bag or tackle box (as shown). The device 100 includes two legs 104 formed continuously with the main body 102, and extending downward from the main body. The legs 104 include securement elements 106 in the form of straps 108 and fasteners in the form of a plurality of protrusions 110, as previously described. It should be understood that any variety of fasteners are previously discussed are also useful for this embodiment.

The present device 10, 100 and its various securement elements 23 and associated variety of fasteners is useful for enabling a single user to carry multiple items of sports equipment at one time and in a balanced fashion. FIG. 1 illustrates one such method, utilizing the present device 10 in conjunction with a tackle box for carrying multiple fishing rods in a horizontal position to each other and the ground. The versatility of the present device 100 is further illustrated in FIG. 6, where the fishing rods are secured in two different positions. Further, although fishing poles are shown, it should be understood that the device may also be useful for other forms of equipment including nets. Additionally, FIG. 8 illustrates use of the present device 10 for securing and carrying different types of sports equipment.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A sports equipment carrying device comprising:
a main body;
at least one leg connected perpendicular to and extending from a side of the main body;
and,
a plurality of securement elements extending from the leg.

2. The sports equipment carrying device of claim 1, wherein the main body includes a center opening.

3. The sports equipment carrying device of claim 2, wherein the center opening is adapted for receiving a handle on a carryall.

4. The sports equipment carrying device of claim 1, wherein the main body includes at least two legs extending from the side of the main body.

5. The sports equipment carrying device of claim 4, wherein the legs are disposed on opposite ends of the side of the main body and positioned parallel to each other.

6. The sports equipment carrying device of claim 1, wherein the securement elements are evenly spaced vertically along a length of the leg.

7. The sports equipment carrying device of claim 1, wherein the securement elements are adjustable straps.

8. The sports equipment carrying device of claim 7, wherein the adjustable straps are positioned at an angle relative to the leg.

9. The sports equipment carrying device of claim 8, wherein the adjustable straps are positioned at angle of more than 90° relative to the leg.

10. The sports equipment carrying device of claim 1, wherein the securement elements further include a plurality of fasteners.

11. The sports equipment carrying device of claim 10, wherein the fasteners are adapted for engagement with a corresponding receiver disposed on each of the legs.

12. The sports equipment carrying device of claim 10, wherein the fasteners comprise flexible protrusions for engagement with receivers on the legs.

13. The sports equipment carrying device of claim 10, wherein the fasteners are adjustable fasteners.

14. The sports equipment carrying device of claim 10, wherein the fasteners are snaps.

15. The sports equipment carrying device of claim 10, wherein the fasteners are hook and loop fasteners.

16. A sports equipment carrying and storage device comprising:
a body having a center opening there through;
at least two legs connected perpendicular to and extending from opposing ends of one side of the body;
a plurality of securement elements projecting outward from each leg, wherein the securement elements further comprise at least one adjustable strap having a plurality of fasteners disposed thereon for engagement with a plurality of receiving elements on each leg.

17. The sports equipment carrying and storage device of claim 16, wherein the two legs are disposed parallel to each other.

18. The sports equipment carrying and storage device of claim 16, wherein the securement elements project outward at an angle relative to each leg.

19. A method for carrying multiple items of sports equipment, the method comprising the steps of:
providing a carryall having a handle;
providing a device comprising a body having a center opening there through and at least two legs connected perpendicular to and extending from opposing ends of one side of the body;
providing a plurality of securement elements projecting outward from each leg, wherein the securement elements further comprise at least one adjustable strap having a plurality of fasteners disposed thereon for engagement with a plurality of receiving elements on each leg, the securement elements adapted for receiving at least one item to be secured thereto;
engaging the handle with the device through the center opening;
arranging the at least one item on the device;
wrapping the securement element around the item; and
securing the item on the device in a suitable orientation to the bag.

20. The method for carrying multiple items of sports equipment of claim 19, wherein securing the item on the device further includes securing the item in multiple orientations.
